(19) United States
(12) Patent Application Publication
(10) Pub. No.: US 2022/0187500 A1
(43) Pub. Date: Jun. 16, 2022

(54) OVERLAY WITH INTEGRAL TABS FOR A DISPLAY

(71) Applicant: 3M INNOVATIVE PROPERTIES COMPANY, St. Paul, MN (US)

(72) Inventors: Steven T. Swartz, Pepperell, MA (US); Keith R. Jacobs, Blaine, MN (US); David C. Mercord, Prescott, WI (US); Michael S. Schrack, Hudson, WI (US)

(21) Appl. No.: 17/593,069

(22) PCT Filed: Mar. 10, 2020
(86) PCT No.: PCT/IB2020/052069

§ 371 Date: Sep. 8, 2021

Related U.S. Application Data
(60) Provisional application No. 62/820,002, filed on Mar. 18, 2019.

(51) Int. Cl. G02B 1/04; C08J 5/18; B23K 26/402

(52) U.S. Cl. CPC G02B 1/04; C08J 2367/02; B23K 26/402; C08J 5/18

(57) ABSTRACT

Overlay is described. In particular, an overlay with integral tabs for a display is described. The integral tabs is made by a laser machining process, to obtain the required thickness of the tabs. The overlay described herein is particularly suitable for display screens of devices such as laptop, tablet computers, cellular phones etc.

### BACKGROUND

Products capable of providing privacy for the consumer have increased. For example, it is very common today for most personal computers and automatic teller machines to include a privacy screen allowing the user to view the image on the monitor while simultaneously limiting the view for bystanders, or at least those not in the viewing angle of the screen. Some have used light control films to provide privacy to a user who has documents containing sensitive material. The idea is similar in that the user can view the image on the document but bystanders are limited in viewing the document's content.

The art discloses various light control films that also serve the purpose of providing privacy to the user. However, as document privacy is becoming more and more of a desire for consumers, those skilled in the art seek different solutions to provide this desired feature. Thus, there is a continuing need for new privacy film constructions.

### SUMMARY

In one aspect, the present description relates to an overlay for a display. The overlay incudes a substrate having a first planar surface and a second planar surface. The substrate is configured to be positioned adjacent to a planar surface of the display. The overlay also includes a plurality of tabs defined integrally along a periphery of the substrate. Thickness of each of the plurality of tabs is less than thickness of the substrate.

In some aspects, the substrate is a privacy film.

In some aspects, the thickness of each of the plurality of tabs is at least 50% lesser than the thickness of the substrate.

In another aspect, the present description relates to a method of forming tabs in an overlay for a display. The method includes, providing a substrate and machining the substrate selectively along a periphery of the substrate to form a plurality of tabs. The plurality of tabs are formed such that each of the plurality of tabs are integrally formed with the substrate. Thickness of each of the plurality of tabs is less than thickness of the substrate.

In some aspects, machining is performed by a laser machining process based on machining parameters which includes laser speed, laser power, amount of laser defocus and laser cut path are selectively controlled to obtain required thickness of the plurality of tabs.

In some aspects, the machining process is CO₂ laser machining process.

### BRIEF DESCRIPTION OF THE DRAWINGS

FIG. 1 is a front view of an overlay for a display.

FIG. 1A is a detailed view of a portion ‘A’ of the overlay as implemented in FIG. 1.

FIG. 2 is a side view of the overlay as implemented in FIG. 1.

FIG. 2A is a detailed view of a portion ‘B’ of the overlay as implemented in FIG. 2.

### DETAILED DESCRIPTION

The present disclosure provides various embodiments of selectively attachable overlay for a display with integrated tabs. According to various embodiments, overlay also referred to as a display cover may be secured to a display of a laptop computer, television, computer monitor, and/or other electronic display device. An overlay may be configured to protect the display, shift a color of the display, dim the display, polarize the display, provide an anti-glare surface for the display, provide a privacy screen for the display, and/or otherwise modify or protect the display screen. Conventionally, such overlay may be secured to a display using adhesives or may be secured to a bezel of the display. For example, a clamp, suction cup, Velcro, a fastener, and/or an adhesive may be used to permanently or temporarily secure an overlay to a display. In various embodiments, the overlay may include dimensions specifically adapted for a particular display. In some arrangements, tabs may be provided in the overlays for attaching the overlays to a raised bezel of the display. In various embodiments, overlays may be utilized in conjunction with a single display.

One such conventional overlay for display is described in WO2013089939. The '9939 document discloses selectively attachable under-bezel tabs including an adhering portion and a securing portion. An adhesive may be used to secure the adhering portion adjacent the edge of a display cover. The securing portion may be secured between a display surface and a display bezel. Accordingly, one or more under-bezel tabs may be adhered to a display cover in order to secure the display cover in front of a display. The display cover may be configured to protect or enhance the display. For example, a display cover may be configured to reduce glare or provide a privacy screen. The selectively attachable under-bezel tabs may be adhered to any of a wide variety of universal display covers, thereby adapting the universal display cover for use with displays configured with slotted bezels adapted to receive specialized display covers.

Other conventionally known tabbed privacy filter includes a Polyethylene Terephthalate (PET) laminated with Optical Clear Adhesive (OCA) to the privacy filter. The PET extended beyond the privacy filter in tabs, thereby created a thin tab that could fit into a laptop/display bezel and have the privacy flush or recessed within the bezel.

However, these conventional arts had issues related to durability (i.e. tab insertion and removal), tabs prematurely failing and was also expensive.

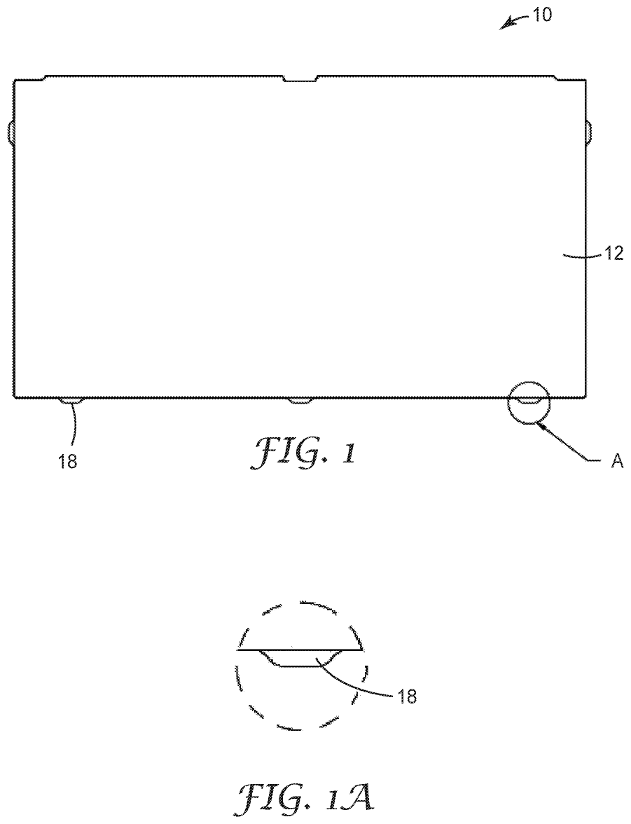

FIG. 1 is a front view of one exemplary embodiment of the present invention showing overlay 10 for a display. The overlay 10 includes integral tabs 18 to allow securing of the overlay 10 to the display. In some embodiments, the overlay 10 may be secured to a display of a laptop computer, television, computer monitor, and/or other electronic display device. The overlay 10 may be configured to protect the display, shift a color of the display, dim the display, polarize the display, provide an anti-glare surface for the display, provide a privacy screen for the display, and/or otherwise modify or protect the display screen. In some embodiments, overlay 10 may also be referred to as display cover.

A “display” as used throughout the specification may include any of a wide variety of active or passive electronic visual displays, or portions thereof. Specifically contemplated and illustrated are the display screens of laptop computers and desktop monitors, including those utilizing plasma, LCD, LED, OLED, E-Ink, and related technologies. However, the term “display” also includes, but is not limited to, the visual displays of electronic readers, tablet computers, tablet PCs, cellular phones, interactive displays, video displays, touch screens, touch computers, and the like.

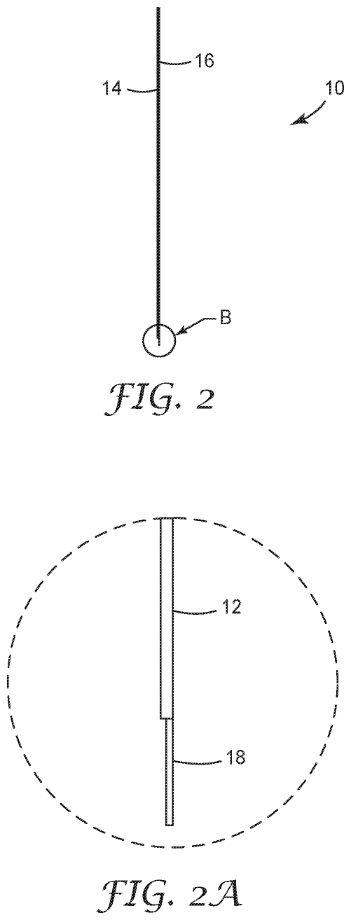

In some embodiments, the overlay 10 includes a substrate 12 [shown in FIG. 2A] having two planar surfaces—a first planar surface 14 and a second planar surface 16, shown in FIG. 2. The substrate 12 may be positioned adjacent to a planar surface of the display. The first planar surface 14 of the overlay 10 may be such that it is proximate to the planar surface of the display and the second planar surface 16 of the overlay 10 is such that it is distal from the planar surface of the display. Further, the overlay 10 includes a plurality of tabs 18 defined integrally along a periphery of the substrate 12. The plurality of tabs 18 are such that thickness of each of the plurality of tabs 18 is less than thickness of the substrate 12. In some embodiments, each side of the substrate 12 may be defined with at least one tab 18. In an alternative embodiment, at least two opposite sides of the substrate 12 may be defined at least one tab 18. In some embodiments, the thickness of each of the plurality of tabs 18 is at least 50% lesser than the thickness of the substrate 12. In some embodiments, the maximum thickness of the substrate 12 may be 500 micron and the maximum thickness of each of the plurality of tabs 18 may be 200 micron. In some embodiments, the cross-sectional dimension of the substrate 12 and the plurality of tabs 18 are substantially constant.

The term “substantially” is defined with respect to the cross-sectional dimension of the substrate 12 and the tabs, wherein it remains constant with minimal variation throughout.

FIG. 1A depicts an exemplary detailed view ‘A’ of a tab 18 that forms an integral part of the overlay 10. In some embodiments, the plurality of tabs 18 allows securing of the overlay 10 with the display. The plurality of tabs 18 may be secured within a raised bezel of the display. In another embodiment, the display may include a plurality of slots defined in its bezel [not apparent from the figures]. The number of slots defined in the bezel may correspond to the number of tabs 18. In an exemplary embodiment, each of the plurality of tabs 18 may be secured in the corresponding slots defined in the bezel of the display. The plurality of tabs 18 may be of different shapes. In some embodiments, the shape of the tabs 18 may be rectangular, diamond-shaped and in some embodiments, the tabs 18 may be swoop-shaped. Swoop-shape may be defined as a movement created by moving high, then moving down quickly, making an arc or loop.

In some embodiments, both the substrate 12 and the tabs 18 may be made of the same material. In one embodiment, formation of tabs in an overlay includes providing a substrate 12, machining the substrate 12 selectively along a periphery of the substrate 12 to form a plurality of tabs. The plurality of tabs 18 are formed as integral part of the substrate 12. Further, the machining may be carried out such that thickness of each of the plurality of tabs 18 is less than thickness of the substrate 12. In some embodiments, the process of machining used may be CO₂ laser machining process. The laser machining process may be carried out using pre-determined machining parameters. In one embodiment, the pre-determined machining parameters includes laser speed, laser power, amount of laser defocus and laser cut path. These parameters may be controlled to obtain the required thickness of each of the plurality of tabs 18.

FIG. 2 is an exemplary embodiment of the present invention depicting side view of the overlay 10 for a display. In one embodiment, the substrate 12 and the tabs 18 are of substantially uniform cross-section along its length. From FIG. 2, it is evident that the thickness of tabs 18 is lesser than the thickness of the substrate 12. In one embodiment, the thickness of the tabs 18 may be at least 50% lesser than thickness of the substrate 12. In some embodiments, the first planar surface 14 of the substrate 12 may be proximate to the planar surface of the display and the second planar surface 16 of the substrate 12 may be distal from the planar surface of the display. FIG. 2A shows a detailed view of a bottom portion of the overlay 10. In some embodiments, the tabs 18 form an integral part of the substrate 12. The tabs 18 may be formed through laser machining process, wherein different parameters may be altered to obtain required thickness of the tabs 18.

In some embodiments, the substrate may be a privacy film. The privacy film may include a light transmissive, polymeric base sheet made of a first polymeric material. Further, the privacy film includes a plurality of light directing elements made of a second polymeric material. In some embodiments, the first or second polymeric material may be selected from a group consisting of thermoplastic polymers and elastomers. In some embodiments, the thermoplastic polymer may be selected from the group consisting of polypropylene, polyethylene, polystyrene, polycarbonate, polymethyl methacrylate, ethylene vinyl acetate copolymers, acrylate modified ethylene vinyl acetate polymers, ethylene acrylic acid copolymers, nylon, polyvinylchloride, and combinations thereof. In one embodiment, the light directing elements interfere with light transmission thereby providing the privacy feature of the privacy film. Optically active materials, such as light reflecting and or light absorbing materials, may be included. In one exemplary embodiment, the heights of the light directing elements may be substantially the same on the privacy film. There may be some variation in the elements heights due to the manufacturing conditions. In another exemplary embodiment, the heights of the elements vary from one region of the privacy film to another region and even from one element to the next adjacent element. By variation in height, it is generally meant that one element will be from 75% to 95% in height of another element.

In some embodiments, the light directing element may be made in various ways. In one exemplary method, the privacy film of the present invention may be formed by extruding a polymeric web through a die having an opening cut, for example, by electron discharge machining. The web would include the base sheet and the light directing elements disposed thereon.

The shape of the die opening may be designed to generate a web with a desired cross-sectional shape or profile. The web may be quenched after leaving the die opening by pulling it through a quenching material such as water. A wetting agent may be added to the quenching medium to wet the entire surface of the extruded web, including spaces between the light directing elements. The extruded web may be further processed, e.g., by applying a light absorbing coating to the tips of the elements or by cutting the extruded elements and stretching the web to form discontinuous light directing elements.

### Examples

Embodiments of the present invention will now be described with examples. The tables below indicate different parameters considered for forming the tabs integrally with the overlay.

TABLE 1

| Tab | Ablation | # of Mark | Pattern | Mark | | | Focus |
|---|---|---|---|---|---|---|---|
| Height | Pattern | Passes | Gap | Speed | % Power | Frequency | Level |
| 3 mm | Parallel to body | 2 | 200 um | 950 mm/sec | 10% | 60 Khz | −1000 |
| 3 mm | Follow contour | 2 | 100 um | 950 mm/sec | 7% | 60 Khz | −1000 |
| 3 mm | Parallel and | 1 | 200 um | 950 mm/sec | 20% | 60 Khz | −1000 |
| | perpendicular- | | Y Gap | | | | |
| | cross hatched | | 100 um | | | | |
| | | | X Gap | | | | |
| 3 mm | Parallel to body | 1 | 200 um | 950 mm/sec | 45% | 60 Khz | −700 |
| 3 mm | 1 Single line | 1 | | 950 mm/sec | 100% | 30 Khz | −30000 |
| | about half way | | | | | | |
| | up on tab | | | | | | |
| 3 mm | Parallel to body | 2 | 200 um | 950 mm/sec | 15% | 60 Khz | −1000 |

Table-1 depicts different parameters obtained while forming the tabs integrally with the overlay with a 400 Watt Carbon-dioxide (CO₂) laser and a 70 mm scanner for analyzing.

TABLE 2

| Tab | Ablation | # of Mark | Pattern | Mark | | | Focus |
|---|---|---|---|---|---|---|---|
| Height | Pattern | Passes | Gap | Speed | % Power | Frequency | Level |
| 2 mm | cross hatch | 1 | 140 um | 1000 mm/sec | 14% | 30 Khz | 0 |
| | | | Perp 200 | | | | |
| | | | um Array | | | | |
| 2 mm | cross hatch | 1 | 140 um | 1000 mm/sec | 14% | 30 Khz | 0 |
| | | | Perp 200 | | | | |
| | | | um Array | | | | |
| 2 mm | cross hatch | 1 | 140 um | 1000 mm/sec | 14% | 30 Khz | 0 |
| | | | Perp 200 | | | | |
| | | | um Array | | | | |
| 1.5 mm | cross hatch | 1 | 140 um | 1000 mm/sec | 14% | 30 Khz | 0 |
| | | | Perp 200 | | | | |
| | | | um Array | | | | |
| 2 mm | cross hatch | 1 | 140 um | 1000 mm/sec | 14% | 30 Khz | 0 |
| | | | Perp 200 | | | | |
| | | | um Array | | | | |

Table-2 depicts experimental data conducted with a 400 Watt Carbon-dioxide (CO₂) laser and a 30 mm scanner was used to analyze the tab.

Both the tables, Table-1 and Table-2 show exemplary data describing the laser parameters used to obtain the tab. The tabs are obtained by developing and refining a repeatable ablation pattern and energy profile for a given laser system. Further, in the exemplary experiments, material of substrate and the tab used was polyethylene terephthalate (PET) based microlouver black privacy filters (available for, example, as 3M™ Black Privacy Filter for Touch Laptops PF140W9E, PF133W9E and PF156W9E from 3M Company). The experiments were conducted to consistently remove or ablate material above the bottom layer of 3 mil PET substrate so as to form tabs.

Further, testing was performed to identify tears or other types of damage that may be caused to tabs. In an exemplary embodiment, the test was performed by inserting and removing the tabs of the overlay into the raised bezel of the display device. In an embodiment, the number of insertion/removal cycles may be 1000. In some embodiments, the test was carried out either till the tabs failed or achieved the insertion/removal specification of 1000 times. The tabs were visually inspected after the test.

1. An overlay for a display, the overlay comprising:
a substrate
having a first planar surface and a second planar surface, the substrate is configured to be positioned adjacent to a planar surface of the display; and
a plurality of tabs defined integrally along a periphery of the substrate,
wherein, thickness of each of the plurality of tabs is less than thickness of the substrate.

2. The overlay of claim 1, wherein each side of the substrate is defined with at least one tab.

3. The overlay of claim 1, wherein the substrate is a privacy film.

4. The overlay of claim 3, wherein the substrate comprises:
a light transmissive, polymeric base sheet comprising a first polymeric material; and
a plurality of light directing elements comprising a second polymeric material.

5. The overlay of claim 4, wherein the first or second polymeric material is selected from a group consisting of thermoplastic polymers and elastomers.

6. The overlay of claim 5, wherein the thermoplastic polymer is selected from the group consisting of polypropylene, polyethylene, polystyrene, polycarbonate, polymethyl methacrylate, ethylene vinyl acetate copolymers, acrylate modified ethylene vinyl acetate polymers, ethylene acrylic acid copolymers, nylon, polyvinylchloride, and combinations thereof.

7. The overlay of claim 1, wherein the thickness of each of the plurality of tabs is at least 50% lesser than the thickness of the substrate.

8. The overlay of claim 1, wherein cross-sectional dimension of the substrate and the plurality of tabs are substantially constant.

9. The overlay of claim 1, wherein maximum thickness of the substrate is 500 micron.

10. The overlay of claim 1, wherein maximum thickness of each of the plurality of tabs is 200 micron.

11. The overlay of claim 1, wherein material of the substrate and the plurality of tabs is similar.

12. The overlay of claim 1, wherein the first planar surface is proximate to the planar surface of the display and the second planar surface is distal from the planar surface of the display.

13. The overlay of claim 1, wherein each of the plurality of tabs is configured to be secured within a raised bezel of the display.

14. The overlay of claim 1, wherein each of the plurality of tabs is configured to be secured within a corresponding slot defined in a bezel of the display.

15. The overlay of claim 1, wherein each of the plurality of tabs are rectangular in shape.

16. The overlay of claim 1, wherein each of the plurality of tabs are diamond-shaped.

17. The overlay of claim 1, wherein each of the plurality of tabs are swoop-shaped.

18. A display device incorporating an overlay as claimed in claim 1.

19. A method of forming tabs in an overlay for a display, the method comprising:
providing a substrate; and
machining the substrate selectively along a periphery of the substrate to form a plurality of tabs, such that each of the plurality of tabs are integrally formed with the substrate;
wherein, thickness of each of the plurality of tabs is less than thickness of the substrate.

20. The method of claim 19, wherein the machining is performed by a laser machining process using pre-determined machining parameters.

21-22. (canceled)
